(19) United States
(12) Patent Application Publication
(10) Pub. No.: US 2005/0033588 A1
(43) Pub. Date: Feb. 10, 2005

(54) Information system comprised of synchronized software application moduless with individual databases for implementing and changing business requirements to be automated

(76) Inventors: Mario Ruiz, Quito (EC); Victor Mejia, Quito (EC); Alan Kaplan, West Orange, NJ (US)

Correspondence Address: I Now Technologies Inc;Attn: Mario Ruiz or Alan Kaplan, 2200 Flecher Avenue, Ft Lee, NJ, 07024, US

(21) Appl. No.: 10/633,959

(22) Filed: Aug. 4, 2003

(51) Int. Cl. G06F 17/60

(52) U.S. Cl. 705/1

(57) ABSTRACT

A method and apparatus for a fully integrated Information System (IS) with modules for each business activity, that can be used individually or grouped in a suite of modules, each module containing its own individual database, and connected via a middleware-like integration device, or Enterprise Service Bus, for network based data synchronization and communications, that connect the modules to each other and to existing ERP, CRM, data warehouse and custom legacy systems. Each module therefore acts more efficiently since it is not burdened by the tasks of interfacing with the hardware platforms and operating systems, which are assigned to the programs in the integration server. These smaller and more flexible modules work together and automatically update all related applications, databases and users, when data is entered into one. The modules are quickly implemented as they are written from libraries of core functionality from existing programming code that were developed for implementing similar business requirements, added to custom code, thus quickly and inexpensively implementing precise individual business requirements, fully integrated with the existing legacy IS environment. The invention is considered a next generation ERP technology that can easily adapt to new requirements as market places and best practices dictate. It is called SAIDware and it is especially suited for the migration of legacy systems to more modern platforms, facilitating their step-by-step replacement as time and budgets allow.

### 1. FIELD OF THE PRESENT INVENTION

The present invention relates to an Information System (IS) application architecture, technology and invention, specifically, the use of modular business software applications that have their own individual databases and synchronizing communications layer, to implement or update an organization's business automation requirements, without incurring large amounts of cost, time, or risk. The architecture is called SAID (Synchronized Applications with Individual Databases) and the technology and embodiments of the invention are called SAIDware.

The first embodiment of SAIDware is the i now Modular Information System, which is unlike any other suite of applications for managing a business, be it a corporation, government agency, institution, etc. It comprises in part, self-contained, custom tailored, stand-alone applications with their own individual databases in each module, containing far less source code and complexity than normal software applications. The specialized modules contain source code in any programming language, with the exact declarative business rules and data input screens relating to the specific events and processes of the departmental users. They work alone, or communicate with other SAIDware modules, as well as with conventional information systems, databases and users, across an existing network (LAN, WAN, Internet, etc.) via a data and message integration device and standard network protocols. This synchronization and communications layer, transfers data and sends and receives messages between modules, applications and databases. This communications layer of the architecture performs all of the more complex functionality related to interfacing with the hardware, operating system, other software systems, applications, modules and databases. The result is slimmed down, completely customizable applications that can be used individually or grouped in a suite of modules that work together and automatically update each other for all business requirements across a department, business, or entire enterprise. As a result of its design, SAIDware is also the only Enterprise Resource Planning (ERP) or other type of business requirements automation software that can be quickly and inexpensively customized to exact user requirements. Also it is the only software-suite with a built-in data integration device to connect the new applications with the existing legacy systems and databases.

### 2. RELATED ART

The prior art consists primarily of larger, custom-made or pre-made applications that share databases and have no fully integrated communications layer. As a result, almost every program, in each application, contains a significant amount of source code that interfaces with other applications, databases and users, added with the code specific to the hardware platform and operating system being used. Conventional applications by nature have far more complexity and are larger in size, making them harder to write, more difficult to change, and less portable to move to another platform as technology changes. As a result, conventional Information Systems containing multiple applications are often so complex, they involve; a large of amount of money to develop, excessive risk in deployment, delays in time to implement, difficulties to test, frequent maintenance and repairs, and problems to upgrade.

In fact, the current state of Information System environments at most medium and large sized corporations, agencies and institutions, can be characterized as a tangled web of system applications and databases that are difficult to understand and cumbersome to control. In many instances, current Information Systems are an impediment to implement changes required for the enterprise to function better. An upgrade of one or more components is usually such an extensive, expensive, and formidable task that the barriers to updating the individual component are only slightly exceeded by the barrier to install an entirely new application and/or change to a more modern architecture.

An additional trend in prior art is the conventional Enterprise Resource Planning (ERP) suites, representing a prepackaged Information System software suite that supports any or all functionality to implement an organization's business requirements. A successful ERP requires effective and timely sharing of information between individual applications and users. Examples in the prior art have not easily achieved this level of effectiveness, despite expending large amounts of frustrating effort and a large expenditure of time and money.

A trend growing in popularity since the late 1990's has been to buy prepackaged ERP applications containing “best practices” for specific work-related functions in a specific industry, i.e. Accounting, Human Resource and Customer Relationship Management (CRM) software applications for automotive manufactures, as an example. If a customer who chooses an ERP and or CRM is willing to adopt these embedded practices and abandon their current business process, implementations of these packages will usually succeed and the cost and risk of implementation is low to moderate. However, upgrading to future business requirements, to compete in the customer's marketplace, may be difficult or impossible, unless the ERP or CRM software vendor has such functionality in their latest versions.

If a customer of ERP and/or CRM applications desires significant customization to adapt the software to their exact business process and rules, this is accomplished by adjusting a parameter settings layer in the software package, and generating custom interfacing and integrating source code. A gap assessment is usually employed as a first step to try to determine the differences between the prepackage application's business processes and those used by the customer. An estimate of the level of effort and cost to modify the application source code, or parameter setting layer is then given. These assessments are often wrong and misleading, underestimating both the cost and time to implementation. The results of the customization process are often unsatisfactory and the architecture and complexity of this conventional software is to blame. Also underestimating the data integration issues is to blame. These are large application programs, with a central database design, that handle all platform functionality along with the business rules and data input screens to run the department or enterprise. The parameter layer is then used to try to close the gap between what the software does “out of the box” and what the customer needs. But the basic problems remain and a more flexible alternative architecture, technology and method are needed, especially for enterprises that need a lot of information integration.

In recent years, enterprises require the integration of information from disparate complex Information Systems; hence the growth in the movement for Enterprise Application Integration (EAI). In an effort to make EAI a reality, middleware has emerged, which is a software and hardware system built in between existing systems, which connects these systems and their users. Middleware is necessary to provide the backbone for EAI within disparate systems and diverse environments, since modifying the existing legacy systems source code, for integration purposes, is very difficult. Therefore, the essential role of the middleware is to manage the interfaces between disparate databases, applications, systems and users, with the goal of giving the users access to high quality integrated information in a timely fashion.

U.S. patent application Ser. No. 20030037174 A1 by D. Lavin et al. describes a method, apparatus, and computer-readable medium, interfacing between middleware software and application software using a plug and socket approach, in which application-specific services and resources are isolated onto the plug and middleware-specific components are isolated into the socket. The plug and socket communicate with each other through an interface. The socket communicates with middleware software through an application program interface, and the plug communicates with application software through an application program interface. Therefore, the plug is isolated from communicating with the middleware software, and the socket is isolated from communicating with the application software. The main disadvantage of this middleware device is that it lacks the presence of the secondary data channel, as is present in the invention. Further, the system taught by Lavin et al fails to reduce the workload of the central database. The prior art system only integrates databases and is not suitable to give the capacity for the applications to update each other.

U.S. Pat. No. 6,415,331 B1 by Ariga represents a classic middleware application that embodies the numerous shortcomings prevalent in the art. Specifically, it is labor intensive to implement and once added to the network it is invasive, and difficult to remove. In addition, Ariga fails to provide for the integration of a secondary data path, instead Ariga teaches the integration of data through utilizing the primary data path, a means of synchronization that inherently hinders the available bandwidth in the system.

U.S. Pat. No. 6,092,096 by Lewis describes a means of routing in data communications networks. Lewis also embodies a flaw that is omnipresent in the art; data routing instructions are saved, partially processed, and maintained via the node itself. In doing this Lewis forces individual network components to deal with external consideration, making them more complicated to build and maintain, as well as having a negative effect on their negative effect by forcing them to deal with more than their internal considerations.

Although there are many patents in the area of application and data integration, no one has used a middleware data and messaging communications type device (now also referred to as an Enterprise Service Bus or ESB) as a part of the intrinsic architecture of the application systems, to simplify and synchronize new enterprise application modules, each having their own databases, and thus gain the efficiencies described herein.

### 3. SUMMARY OF THE PRESENT INVENTION

The present invention relates to an enterprise application architecture, technology and invention called SAIDware, specifically designed where each new, or migrated application has its own database, and a built-in middleware-like data communications layer (or ESB), that keeps every related module, database and user, updated with new data entries that are input anywhere the system. SAIDware is also suitable for use in upgrading an organization's existing applications and data integration capabilities, modifying business processes, workflow and business rules, without requiring complete application replacement. The current embodiment of the invention is called the i now™ Modular Information System, but SAIDware, as a method, is intended to be licensed and used by many other ERP suppliers and custom application developers in the future.

SAIDware is a new type of enterprise Information System architecture, technology and invention, with a level of application and data integration capabilities heretofore unavailable. Application development and data integration can be performed using SAIDware in new and existing systems, as a means to avoid the implementation of additional conventional ERP applications and middleware packages. SAIDware, in a generic sense, represents the future of modular application development and data integration technologies, allowing best practices libraries (perhaps extracted from existing ERP and legacy programs) embedded into smaller modules with individual databases, interacting by means of any type of middleware integration engine, or ESB, as the synchronization and communication layer. This invention by nature possesses a functional advantage over all existing other Information Systems, technologies and architectures.

The present embodiment employs a network-based data synchronization, communication, and transformation system. The i now™ Modular Information System comprises self-contained stand-alone application modules, with their own individual databases, that can be used individually or grouped in a suite of modules that work together and automatically update each other (along with all other enterprise components and users) to more easily implement all business requirements across a department, or across the world, via the Internet. Specifically, the three software components comprising the first embodiment of SAIDware are; 1) inow™ Modules, 2) Synchronizer™ Connectors and 3) the Harmonizer™ Integration Server.

In the present embodiment, a connecting device called the Synchronizer™ and a server based communications device called the Harmonizer™ are employed to interface the plurality of i now™ Modules and tie these modules to existing legacy applications and databases, where such applications exist, and integration of the information in these legacy systems with the new applications is desired.

The modules are smaller than normal applications, as they are providing precise business services to smaller groups of users. They are also smaller because they contain less system interoperability related code. They allow for the reuse of libraries of core—related functionality (often standard and custom-made objects) with the addition of customization code tailoring the functionality to the exact 100% requirements of the department. This method of development and customization enables a lower cost implementation that occurs in weeks, not months or years. The risk of not being able to customize 100% (so prevalent in conventional ERP packages) is virtually 0% in the smaller modules with their own, individual databases.

The Synchronizing Operation Modules (SOM's), or Synchronizer™ in the current embodiment, operate as a means of connection between individual modules, existing legacy applications, databases and the Harmonizer™ Server. The SOM's connect programs that capture inow™ Modules or legacy system data from applications and databases, and prepare them for data transport and/or harmonization. SOM's are two-way devices, whereby the same SOM that extracts also inserts, to and from an application or database. However, the functionality of the SOM's is beyond that of a mere data extraction and insertion conduit, as each individual SOM also acts, in part, as a data staging and preparation area, the SOM can also put the data in a standardized or custom formats prior to forwarding it to the Harmonizer Integration server which performs other operations and thereafter, sends the data on to its destination, which is another SOM used to receive and insert the data.

SOM's connect databases via triggers, or applications by the insertion of new read and write statements in the source code of the modules and legacy applications. The code is then compiled inside the modules or applications, and produces an exact duplicate of the tables to be stored in the database, which is then forwarded to the Harmonizer. This is what is referred to as a “secondary data path” in the case of legacy applications and database generated data.

The Harmonizer™ Integration server acts as the hub of a spoke and hub data integration design. The Harmonizer receives data from a given SOM, which is placed in a queue in near-real time. It then (in turn) acts as a data staging and manipulation area, where a record is opened and wrapped in XML. Then XML parsing of the data occurs. Transformations are performed, matching data formats, put into the outgoing queue, and forwarded to the appropriate SOM, once rule-based calculations or any other processing of the data have been performed. SOM's can also deal with XML, sending, receiving, wrapping, and unwrapping in the highly useful language. The Harmonizer™ Integration server can thus remove substantial data integration and platform related workload from the individual modules through its handling of the forwarding and transforming of information, thus allowing for the simplification of the applications' internal functionality. i now Modules are therefore easier to implement, test, maintain and modify.

The present embodiment demonstrates some of the capabilities of this unique IS application architecture, technology and invention, comprised of smaller, stand-alone modules with individual databases, and a data synchronization and communication layer, with each module having only to deal with its own internal functionality. The Synchronizer™ Connectors and Harmonizer™ Integration server deal with all external considerations and extraordinary interoperability across the enterprise is the result.

The i now Modules™ in the current embodiment, can be purchased and implemented individually or in a suite of more than 30 modules grouped together so as to facilitate application and data integration. The construction of the SAIDware based system is such that libraries of functionality previously developed, can be custom integrated with a customers exact business processes, interfaces and data input screens, eliminating the need for parameter setting layer to accomplish this task. It allows for quick integration of modules, often acting as precision mini-database applications, each containing mostly declarative business rules that are precisely matched to the user's exact business events, processes and rules, as well as data input and output requirements, including but not limited to, event planning, process automation, and user interfaces.

The invention and current embodiment, also contains a variable parameter settings feature—a layer of code that adjusts the user's workflow and processes to pre-approved sets of variations. Users, who may wish to change the way they do their work themselves, can change the system at a functional level. When they develop new ideas that management approves, additional parameter driven functions can be added, to give the users the ability to use these new processes. This next generation ERP feature can only be implemented and changed in SAIDware, where the amount of code in each module is small and manageable enough to implement these functions while (due to the synchronization and communication layer) the interoperability between modules is not affected.

In one embodiment, each module of the present invention can be programmed from new or existing business requirements in a simpler, smaller, faster and more manageable way than the conventional ERP or previous custom-designed applications without individual databases.

In another embodiment of the present invention the modules can be built from libraries of core functionality, defined as procedural code, objects and services that may contain similar, or even ‘best industry practices,’ reusable from previously built modules for other similar custom requirements. This core functionality may then be wrapped in custom code that duplicates the exact business processes, workflow, data flow, interfaces, and data input screens that the customer requires.

In another embodiment, code from legacy systems can be repackaged into SAIDware by reworking the original code into individual mini-database modules, with their own databases, that will then be recompiled and sit on any platform on which the databases can be hosted. One example of this is Oracle, a database brand that can be used on mainframes, AS/400's, Unix, Windows, Solaris, Linux, etc. When SAIDware modules are hosted in Oracle, they can be moved to new platforms as technology and customer preferences change.

In another embodiment, legacy source code can be rehosted, translated or rewritten into individual modules with their own separate databases as discrete (non-database language) modules. Examples are (but not limited to) mainframe or AS/400 COBOL rehosted to Unix COBOL. COBOL translated into Java code (that is platform independent). COBOL to SQL, or PL/SQL or any other type of original programming language, rehosted, translated or rewritten into any target language and nested into SAIDware modules.

Therefore, the present SAIDware embodiment, called the i now™ Modular Information Architecture, provides a system that allows for rapid deployment of new functional requirements by means of code reusability (from libraries of core functionality and transformed legacy code) of the core business needs, customized to match the exact business requirements of every user in the organization.

This invention also lowers the cost and risk of implementing new ERP and CRM applications, which may or may not be suitable, to adapt to a customer's specific business events, processes and rules. In the current art, the more customization required, the higher the price, as the customization layer manipulation usually costs two to seven times the license fees for the off-the-shelf software licenses. Many implementations of the conventional ERP/CRM kind, fail entirely and the managers who recommended their implementation are fired.

The main object of the unique modular information system architecture and software development technology is to simplify the development of precision applications for departments, businesses and the enterprise from concept, design, and prototype through production, test, QA and maintenance, without losing uniformity and integration integrity, thus allowing the information technology department personnel and systems users to proactively contribute towards the everyday functioning of the organization.

A further object of the invention is evident when an existing environment of legacy systems, databases and data warehouses, adopts the SAIDware design, to relieve the pressure caused by EAI initiatives that occurs between programmers and data integrators during systems migrations and integration initiatives. The case for the implementation of the new EAI functionality within a module, while enabling data integration requirements in a separate integration server, gives all departments and the entire enterprise the ability to upgrade, while sorting out and simplifying the difficult tasks of integrating data generated from large, inflexible, unmanageable, and mostly undocumented ERP, CRM, data warehouse and custom developed legacy systems. This invention therefore enables additions and changes to be made to the functionality of a departmental module(s) while retaining interoperability with the other corporate modules. Conversely, this invention enables additions and changes to be made to the interoperability of the data to be integrated with the other corporate modules while maintaining the functionality of a departmental module(s). Its use in EAI initiatives therefore divides the application and data requirements and makes for a more orderly and coordinated project.

Yet another object of the present invention is to allow the Information Systems department to transform itself into a proactive contributor towards the corporate solutions environment and overcome previous impediments to change. With SAIDware, the IS department can now take almost any new requirement, select the targeted application and data areas within their enterprise, and quickly design and build appropriate (and fully integrated) modules to implement the required business functionality and/or data integration, without the cost, risk, time and embarrassment of using more cumbersome application and data integration technologies with less flexible architectures.

Yet another object of the present invention is to be able to add business related functionality, no matter how complex, without the need to modify very large-scale large applications. By attaching multiple smaller modules with their own databases (inow Modules in the current embodiment) to the synchronization and communication layer (Harmonizer in the current embodiment), the IS department can enhance enterprise, department and user functionality in a quick and efficient manner, without disturbing the original conventional ERP and custom legacy systems. In this way, the IS department can start with a user's data integration requirements and add highly complex business functionality as needed, with little time, risk and expense, without creating large-scale new applications or buying additional ERP applications.

Yet another object of the present invention is to more easily facilitate the data communication, data integration (two way extracting, transforming and loading of data between disparate systems) and data availability problems between the IS applications and the IS users who require accurate, near real-time and batch processed information. The middleware integration server, or ESB can have full two-way ETL capability, either internally (as in the case of the Harmonizer) or by means of an additional tool.

Yet another object of the present invention is to improve data sharing across a mixed legacy environment, especially making it accessible to Internet users, thus allowing Internet users to access near-real time data and batch processed information.

Yet another object of the present invention is to provide a data communications layer that forms a secondary data path (parallel to legacy databases) that removes load and responsibility from the primary database. This allows the primary database to perform less of a workload and have higher availability for the users.

Yet another object of the present invention is to eliminate the need for costly and time consuming gap assessments and gap analyses, which are not needed when 100% of the user requirements are implemented via the SAIDware architecture, technology and invention.

### 4. BRIEF DESCRIPTION OF THE FIGURES

FIG. 1 represents Independent Modules for Specific Activities (e.g., Inventory and Accounting).

FIG. 2 represents an Example of Two Independent Modules that need the same information (e.g., Inventory and Accounting).

FIG. 3A represents the Traditional (or conventional) ERP and Custom System Architecture.

FIG. 3B represents the SAID architecture, technology and invention, including the inow Modules, Harmonizer™ Integration server and Synchronizer™ Connectors or SOM's (herein referred to as Mailboxes that appear next to apps and databases).

FIG. 4 represents uses of the Harmonizer™, described in detail in and subject of a co-pending application.

### 5. DETAILED DESCRIPTION OF THE PRESENT INVENTION

The present embodiment of the SAIDware invention, herein, called the “inow™ Modular Information System”, is unlike any other IS application architecture, technology or invention. Its unique feature is that the system is made from simplified software application modules, each with its own, individual database. The inow Modules can be used individually, or grouped in a suite of modules that work together. The simplified modules use libraries of core functionality pre-developed for similar requirements, and can be easily reprogrammed to implement the precise business requirements and data input screens for each customer across their departments, business units, and the enterprise. An important feature of this technology is a unique network-based synchronization and communication layer of the architecture, known as the Harmonizer™, that is employed to interface multiple i now™ Modules that are currently or soon-to-be designed, connecting one or more of them to each other and to an existing enterprise application and database environment. The Harmonizer™ is the subject of a co-pending patent application entitled ‘SYSTEM COMPRISING I NOW HARMONIZER™ FOR INFORMATION SYNCHRONIZATION AND COMMUNICATIONS’ and filed at approximately the same time. The present invention resembles a traditional or conventional Enterprise Resource Planning (ERP) suite of business applications, but it comes with modularized functionality and multiple databases, synchronized with a built-in middleware integration engine or Enterprise Service Bus (ESB).

The term ‘module’ as defined herein means a software program that is a part of an information system, consisting of a logical section of an application that accomplishes a specific business activity within an organization, and contains an individual database for those users. The present invention comprises a variety of modules including, but not limited to, the Inventory module, the Accounting Module comprised of the General Ledger module, the Treasury module and others, the Fixed Assets module, the Receiving module, the Purchasing module, the Planning module, the Research & Development module, the Engineering module, the Manufacturing Planning module, the Manufacturing Controls module, the Shipping module, the Sales module, the Marketing module, etc.

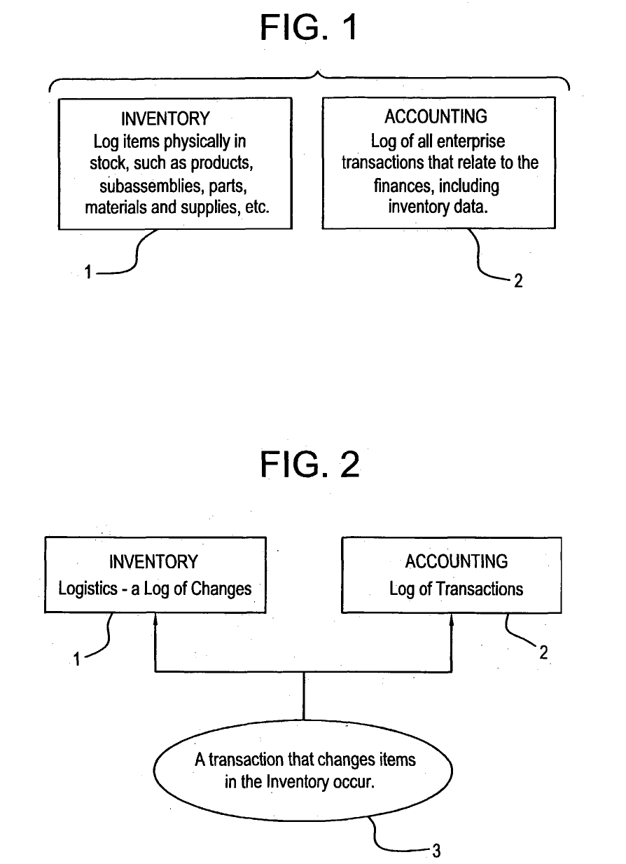

FIG. 1 represents an example of two independent modules for specific activities, for example the Inventory module (1) and the Accounting module (2).

The Inventory module (1) includes, among other items, a log of items physically in stock, for example, products, subassemblies, parts, materials, or supplies. The Inventory module (1) manages items in stock along with inputs, which are incoming items from the receiving area and for other internal item sources, and outputs, which are outgoing items sent to the shipping area and/or other internal item users.

The Accounting module (2) includes, among other items, logs of all enterprise transactions that relate to the finances, including inventory data.

The Accounting module (2) designed for the task of accounting, is provided for registering all financial transactions, some of which require the inventory module data comprising values entered into the module as fields in tables, which are also called values in records that are contained in separate files.

A ‘specific activity’ as defined herein represents a group of related tasks within a single endeavor or department, including for example, planning, purchasing, receiving, research and development, engineering, manufacturing, shipping, selling, marketing, or accounting, each of such activities are contained each in a different module.

The Inventory module (1) and the Accounting module (2) work independently due to the divergent nature of their tasks. In practice, whenever there is some type of physical movement of items into and out of the warehouse, this movement of items is then recorded in the inventory module (1); since this activity is related to a financial transaction, the Inventory related portion of the Accounting module (2) is therefore also updated as soon as possible in near-real time. In other words, a unique feature of the present invention is that the Inventory module (1) and the Accounting module (2) have instant communication between them, which is not dependent on the central server or platform. If the modules did not have communication between them, the updating operations would have to be entered manually (or automatically introduced, as in the case of EDI) into every module that needs updating of all or part of the record. Another alternative in a conventional suite of applications is that the applications would share the same database, which has drawbacks to the independent nature of the modules that are the subject of this invention.

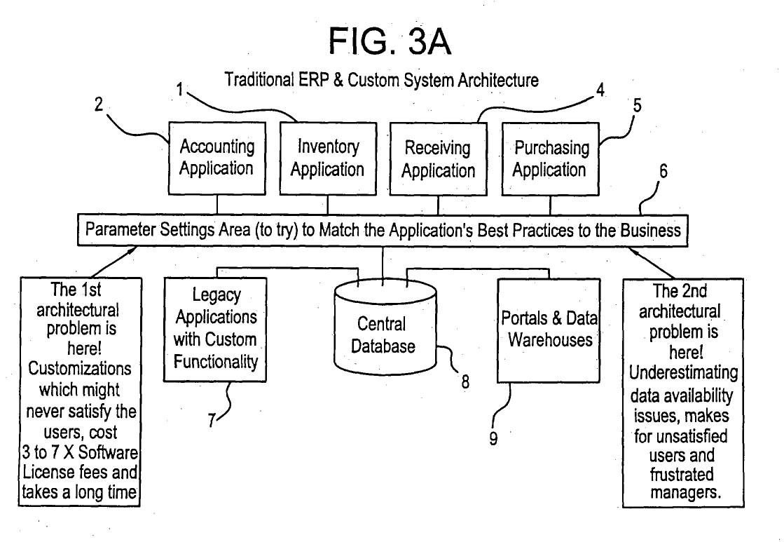

FIG. 2 exemplifies two independent modules, the Inventory module (1) and the Accounting module (2), each requiring the same information. A transaction (3) that changes items in the Inventory module (1) is also recorded in the Accounting module (2).

The unique feature of the present invention is the process by which a transaction is recorded in each module that must process it. Specifically, when an transaction is entered in one module every other module that needs to receive, or be aware of it, does receive it immediately, without having to manually enter the transaction into the other modules.

In the methods employed in the prior art, most information systems attempt to automatically update other applications and users from a central database or central server, but not from the individual module. The current methods do the updates from the central database via triggers that notify applications and users who need to receive the file of the updated information after the database receives it.

The present invention provides a process by which the same update is entered into every module that needs to receive it, while only being manually entered (or automatically introduced, as in the case of EDI) into a single module. The process comprises a series of steps including creating:
1. A language for communication,
2. A network path for the data transfer to every module that needs the update,
3. A SOM connector that gets the information and forwards it,
4. A receiving area that is attached to a staging area that gets the message and passes it on,
5. A staging area that opens the record and sets up the appropriate tables,
6. A device to perform operations on the open record in the staging area that are required by other modules,
7. A sending area that is attached to the staging area to forward the new message to the waiting SOM, and
8. The entering of the data in the mailbox and into the transaction log of the module that needs the update.

Therefore, by applying the above process steps, every module operates independently and at the same time communicates with other related modules and databases, to achieve interoperability. Every concerned manager can receive a message about the change, as well. For example, the Comptroller could be notified if the maximum allowable inventory on a specific item has been exceeded. Or, the purchasing Agent can be notified when the inventory of an item falls below the minimum allowable quantity.

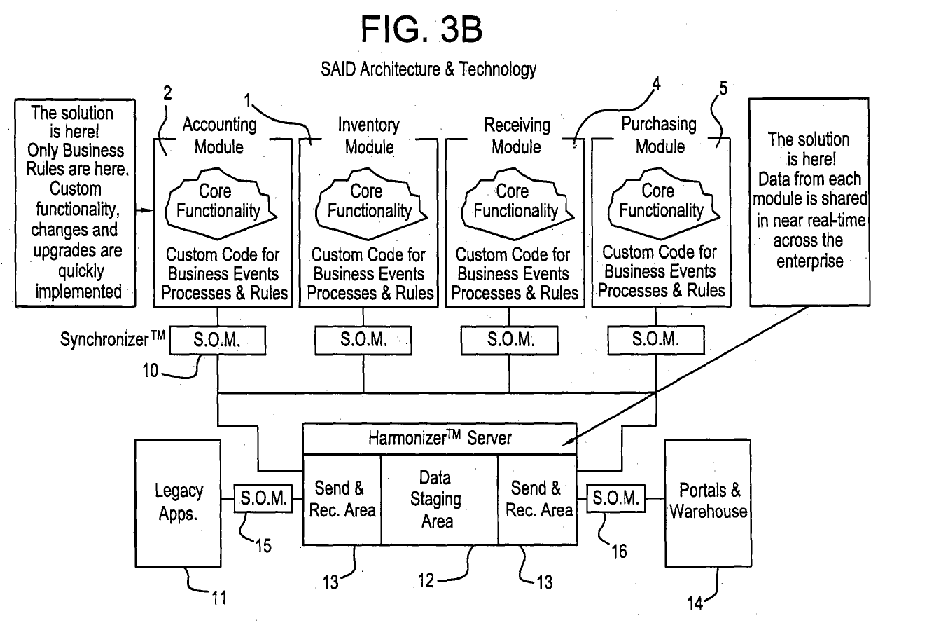

FIG. 3A describes a traditional or conventional ERP and a custom system architecture that includes the Inventory Application (1), the Accounting Application (2), Receiving Application (4), Purchasing Application (5), Parameter Settings area to try to match the application's best practices to the events, processes and rules of the customer's business (6), Legacy Applications with Custom Functionality (7), a Central Database (8), Portals (for Internet users) and Data Warehouse(s) (9). In the traditional or conventional ERP, the modules (1), (2), (4), and (5) do not have lines of communication directly between them, and therefore any updating operations have to be either entered manually into every module that needs updating from all or part of the record. In the alternative, their central database must be used to perform the updates to the data generated by the applications.

FIG. 3B describes the Network Based Architecture of i now Module198 and the Harmonizer retrofits of the present invention. Modules (1), (2), (4), and (5) have communication between them via a plurality of SOM's using standard network protocols (TC/PIP as an example) (10). A bi-directional receiving and sending area (13) that is attached to the staging area (12) gets the message and passes it on. The staging area (12) opens the record and sets up appropriate tables and performs operations (usually, but not limited to, data format transformations) on the open record in the staging area, operations that are required by the other modules, applications and databases, in order to use the information. A sending area that (13) is attached to the staging area (12) forwards the new message to the waiting SOM of the recipient, where the transformed record is inserted.

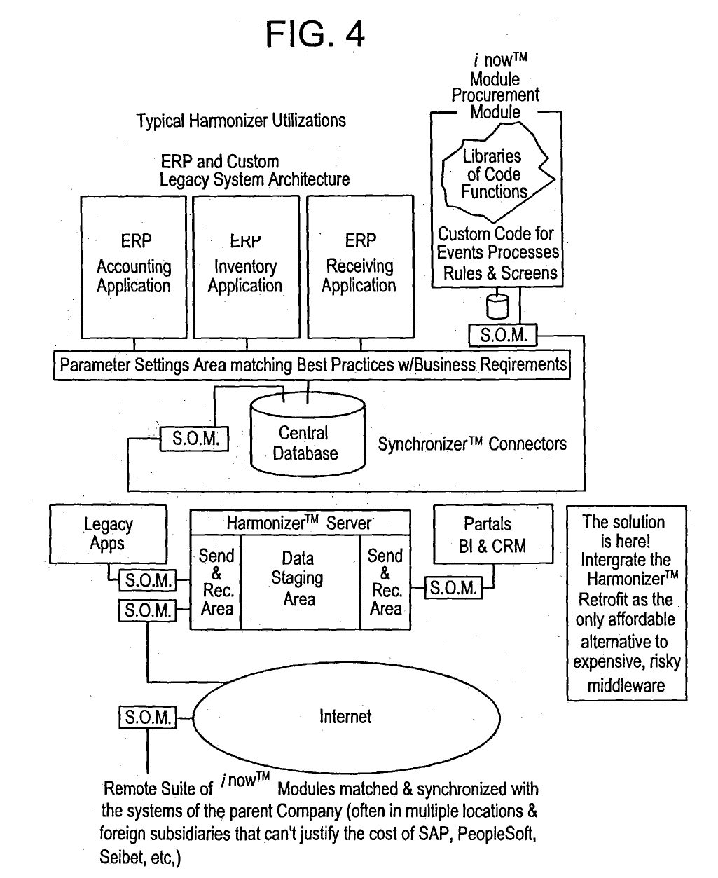

FIG. 4 describes the Harmonizer™ as a retrofit to interface with the i now Modules that ties these modules to existing legacy applications for updating purposes, including (but not limited to) information synchronization and communication. The Harmonizer™ is described in detail in a co-pending application.

SAIDware is a new type of Enterprise Information architecture, technology and invention, with a low cost of implementation and complete data integration capability heretofore unavailable. SAIDware represents the future of application development, next generation ERP and data integration technologies, providing for information synchronization and communication, thereby creating a functional and commercial advantage over all other existing systems. Enterprise Application Integration (EAI) can also be better performed using SAIDware integrated into existing systems, as a means to avoid the implementation of invasive middleware and additional conventional ERP/CRM applications (or custom developed application systems) that inherently involve high-costs and substantial risks during implementation.

The present embodiment employs a network-based data synchronization, communication, and transformation system. The i now Modular Information System comprises self-contained stand-alone application modules, with their own individual databases, that can be used individually or grouped in a suite of modules that work together and automatically update each other (along with all other enterprise components and users) to more easily implement all business requirements across a department, or across the world, via the Internet.

Specifically, the information system software components that comprise the embodiment of SAIDware are; 1) inow™ Modules, 2) Synchronizer™ Connectors (SOM's), and 3) the Harmonizer™ Integration server.

In the present invention, a connecting device called the Synchronizer™ and a server based synchronization and communications device called the Harmonizer™ are employed to interface the plurality of i now™ Modules and tie the modules to existing legacy applications and databases, where such applications exist, and provide for the integration of the information in these legacy systems with the new applications is desired.

The Synchronizing Operation Modules (SOM's), or Synchronizer™, operate as a means of connection between individual modules, existing legacy applications, and the Harmonizer™ Server. However, the functionality of the SOM's is beyond that of a mere data conduit, as each individual SOM also acts in part as a data staging and preparation area, putting data in a standardized (i.e. XML) or custom format, prior to forwarding the record or message it to its destination. The SOM's connect programs that capture inow™ Modules or legacy system data and prepare them for data transport and/or ‘harmonization.’

The Harmonizer™ Integration server acts as the hub of a spoke and hub data integration design. The Harmonizer Server further acts as a data staging and manipulation area, where data received from a given SOM is opened, put into the appropriate format, and forwarded to the appropriate SOM, once rule-based calculations or any other type of transformations have been performed. The Harmonizer™ Integration server removes substantial workload from the individual modules through its handling of the forwarding of information, thus allowing for the simplification of their internal functionality and the reduction in the amount of code they contain.

The present invention therefore provides a unique IS application architecture comprising of smaller, stand-alone modules with their own databases, and a data synchronization and communication system (or layer), each module having only to deal with its own internal functionality, and the Synchronizer™ connector and Harmonizer™ server having to deal with all external considerations.

The i now Modules™ in the current embodiment, can be purchased and implemented individually or in a suite of more than 30 modules grouped together so as to facilitate application and data integration. The construction of the SAIDware based system is such that libraries of functionality previously developed, can be easily integrated with custom code that affords a customers the exact business events, processes, rules and data input screens required, eliminating the need for parameter setting layer to try to accomplish this task in conventional ERP design. It allows for quick integration of modules, often acting as precision mini-database applications, each containing mostly declarative business rules that are precisely matched to the user's exact business events, processes and rules, as well as data input and output requirements, including but not limited to, event planning, process automation, and user interfaces.

The present invention is a network-based data communication, validation, and transfer system. Said system comprises a multiplicity of modules, each of which are capable of operating as stand-alone modules or as part of a suite of modules. Each module being assigned to a specific business activity, including but not limited to; human resources, accounting, purchasing, budgeting, engineering, servicing, or inventory. Each of said modules can interface with existing legacy applications through the Harmonizer. Once grouped together in a suite, a transaction entered in any module will be communicated to all relevant modules via the use of a secondary data path, thereby reducing the data responsibility of the primary database while making the primary database more available to users, among them Internet and business intelligence users accessing them via the network.

Each module is built from a combination of standard codes, which are libraries of procedural codes and objects that may or may not have been used in the construction of previous modules, and custom code. Standard codes can be used because there are certain transactions that are similar, if not identical, in all businesses. For example, the process of cash withdrawal is relatively consistent from business to business. However, there may be minute idiosyncratic variations on the process of withdrawing cash that are specific to an individual organization. The standard codes are then wrapped in, and modified with, custom code that reflects the company specific business processes and other customer requirements, including but not limited to, screen appearance, dataflow, or interfaces.

As described above, in ‘Related Art’ it is common for single applications to perform multiple tasks. The creation of individual modules with their own databases, for performance of single (or smaller groups of) functions, facilitates rapid and low cost construction, while creating performance and efficiency advantages over systems where single applications are forced to perform multiple functions. Traditionally, modules were forced to handle the assignment of paths, or end locations, to data. By definition these modules would have less available capacity to handle their business activity. In removing the burden of sending data between modules, each individual module is allowed to operate at a higher capacity.

An essential element of the present invention is the presence of a synchronization and communication layer of the architecture, technology and invention, which is established by the Harmonizer. This device (or any similar device) connects each module's individual database, and allows data to be transferred and transformed from a given module to any other module, and messages to be sent to any concerned users. The Harmonizer also establishes a secondary data path, with respect to integrated legacy applications. This process of sending data directly via a secondary data path reduces dependency on the central database. The secondary data path becomes capable of handling increasingly more tasks after installation. Information updates allow for instantly synchronized data in near-real time, where traditional systems often rely on the use of periodic batch interval updates. The central database is therefore also capable of handling more requests from users in the present invention, than it would be in a traditional system. Most industries require frequent batch updating. Each update has the effect of temporarily reducing the availability of the system's database, thereby reducing the accessibility to users, including those within the network and those wishing to access it from the outside. The invention reduces the need for batch updates and increases database availability and utilization.

The current embodiment's Harmonizer™ communicates batch updates as well, for the purpose of data integration, whereas it is common in the prior art for batch updates to be handled by separate (and often expensive) Extract, Transform and Load (ETL) tools.

Communication between modules is handled outside of the core functioning of each individual module. A transaction manually entered (or automatically introduced, as in the case of EDI) into a given module is sent via an individual mailbox to a receiving area. The receiving area forwards the message to the central staging area, which in turn opens the record and the appropriate tables. A device then performs the operations that are required by the other modules. The appropriate information is then sent, via a sending area, to the mailbox of the respective recipients. The result is that each module receives only the information it needs, and no irrelevant information, without placing an unnecessary workload on the central database.

The role of the Harmonizer is central in this process. It is preprogrammed with multiple operations that determine which data elements must be sent to which locations. The system assigns individual mailboxes to each module, thereby allowing data to be sorted and delivered more efficiently, while being better aligned with the organization's business processes and practices. Transactions are sent through custom code designed for the purpose of reflecting these business processes and practices of the organization and transforming the data into formats used by other modules and/or legacy applications and databases.

The above-described features of the present invention make it the most effective ERP system available—truly a next generation design and apparatus. No other system allows for the efficient and timely direct sharing of data as in the present invention, without placing unnecessary strain on the central database.

Therefore, the present invention provides individual modules for each business activity, thus simplifying the internal workings and construction of each module. The present invention also provides multiple modules, each with their own individual database, thus simplifying the construction of the entire system, giving it cost, performance and efficiency advantages over designs with clustered applications and central databases. The present invention further provides the use of libraries of core functionality inside the simplified module, allowing for ERP-like ‘best practices’ and custom code more easily written for precision-made data input screens, interfaces, and workflow incorporation.

The above combination of libraries of core functionality with custom code written for data input screens, interfaces, and workflow incorporation, provide exact functional requirements of users and managers instead of gap assessing and trying to customize standard applications via a parameter settings layer. The results are lower cost and risk, and quicker time to implement, as well as a higher degree of customer satisfaction and usability.

The above libraries of core functionality and custom written code for data input screens, interfaces, and workflow incorporation, also provide a quick, efficient, low cost, and low risk way to provide functional requirements of users and managers instead of trying to make custom applications from scratch.

The above libraries of core functionality and custom written code for data input screens, interfaces, and workflow incorporation, also provide for the introduction of users being able to change their work processes, via pre-approved sets of parameters, adjusted as each user sees fit.

The present invention also provides a network (LAN, WAN, Internet, etc.) based interconnection device between the modules when more than one module is used to transfer data between them.

The present invention also provides the interconnection device that is able to transfer data to and from other programs, applications, and databases in an existing legacy environment, without additional middleware. The interconnection device is also able to transfer data to and from other programs, applications and databases in an existing legacy environment as a retrofit system to improve data efficiencies and communications.

While the above description contains many specifics, these specifics should not be construed as limitations on the scope of the present invention, but merely as exemplifications of preferred embodiments thereof. Those skilled in the art will envision many other possible variations of the described embodiments of the present invention.

1. A method of establishing an information system comprised of;
a. one, or a plurality of self-contained stand-alone modules,
b. a central data integration and messaging server, to allow said modules to communicate with each other, and to existing applications and databases, and
c. a series of connecting devices for each of said modules, as well as other applications and databases, interfacing them via a network (LAN, WAN, Internet, etc.) to a central data integration and messaging server.

2. A method of establishing a system according to claim 1, wherein each of said modules performs a specific activity, said activity selected from the group consisting of (but not limited to) business activities including accounting, budgeting, engineering, inventory, manufacturing, purchasing, receiving and sales, etc.

3. A method of establishing a system according to claim 1, wherein each of said modules that performs a specific activity, has its own individual database.

4. A method of establishing a system according to claim 1, that has multiple modules that when synchronized, fulfill each business requirement in a highly efficient and effective manner, thus simplifying the construction of software applications and the entire system, giving it cost, performance and efficiency advantages over designs with clustered applications and central databases.

5. A method of establishing a system according to claim 1, that has multiple modules that when synchronized, fulfill each business requirement in a way that allows for independent activity and highly complex combined functionality between the modules, without the need to make larger software applications that would become more and more complex, larger and unwieldy.

6. A method of establishing a system according to claim 1, that has multiple modules that when synchronized, fulfill each business requirement in a way that allows for the setting up of user changeable parameters that can affect the business events, processes, rules and workflow.

7. A method of establishing a system according to claim 1, wherein each of said modules is interconnected by a synchronization and communication device integrating information as an inherent part of its functionality, architecture and design.

8. A method of establishing a system according to claim 1, for network based (LAN, WAN, Internet, etc.) data transfer and messaging, updating each related module, database and user, as well as to existing applications and databases.

9. A method of establishing a system according to claim 1, wherein each of said modules is interconnected by a connecting device for the purpose of extracting and inserting data and messages to be communicated.

10. A method of establishing a system according to claim 1, wherein each of said modules is interconnected by a connecting device directly exchanging information together, in a hub and spoke manner, without the need for a central database that stores and retrieves data in between system components, including said modules and users, as well as to existing applications and databases.

11. A method of establishing a system according to claim 1 that provides a means for synchronizing and communicating information between system components, including said modules and users, as well as to existing applications and databases, in both a near-real time manner and a two-way extract, transform and load (ETL) batch manner.

12. The method of establishing any ERP or custom designed system with a built-in middleware-like integration server, providing a means for synchronization and communications with existing legacy applications, databases and users to connect and integrate them as an integral (and integrated) part of its design, without the need for external and/or additional middleware or Enterprise Service Bus type devices.

13. The method of establishing an ERP or other type of information system according to claim 3, with less code inside each module, providing a means for said modules to be more easily developed, tested, implemented, maintained, modified (for future requirements) and migrated to new platforms.

14. The method of establishing an ERP system according to claim 3, further comprising a library of core functionality, with custom code to implement exact business requirements, interfaces and data input screens of a customer, said codes being a means to implement industry best practices into a customer's business, reducing, or eliminating the need for a gap assessment.

15. The method of establishing an ERP system according to claim 3, further comprising a library of core functionality, with custom code to implement exact business requirements, including the events, processes, rules, interfaces and data input screens of a customer, said combination of codes being a means to implement industry best practices into a customer's business, reducing, or eliminating the need for a parameter setting layer of interfacing code that attempts to customize pre-made applications.

16. The method of establishing custom developed system according to claim 3, further comprising a library of core functionality, with custom code to implement exact business requirements, including the events, processes, rules, interfaces and data input screens of a customer, said combination of codes being a means to implement exact functional requirements of the users, instead of trying to make custom applications from scratch or by means of reusable code, objects and services, that do not have the advantages of being developed in a development environment comprised of synchronized simplified modules with individual databases.

17. The method of establishing a system according to claim 1, further comprising a variable parameter settings feature that consists of a layer of code which adjusts the user's workflow and processes to pre-approved and pre-made sets of variations, enabling users who wish to change the way they do their work, to change the system at a functional level themselves, without the need for programmers.

18. The method of establishing a system according to claim 1, further comprising a secondary near-real time data path as an inherent part of its design, to improve data sharing and increase database availability by reducing the need for batch processing, across a mixed legacy environment.

19. The method of establishing a system according to claim 1, that has a less invasive means of implementation, starting with data integration purposes primarily, and secondarily providing business functionality.

20. The method of establishing a system according to claim 1, which has a low risk of implementation, often starting with low cost or no cost proofs of concepts.

21. The method of establishing a system according to claim 1, which has a means of being more sensitive to the existing IT culture and political events in an organization, that effect the outcome of any software implementation project.

22. The method of establishing a system according to claim 1, which has a means of reorganizing existing code that has a conventional application with a central database and/or traditional ERP design, into modules for each business activity, that can be used individually or grouped in a suite of modules, each module containing its own individual database, and connected via a middleware-like integration device, or Enterprise Service Bus, for network based data synchronization and communications, that connect the modules to each other and to existing ERP, CRM, data warehouse and custom legacy systems.

23. The method of establishing a system according to claim 1, which has a means of reorganizing code that has been rewritten or translated from other programming languages into modules for each business activity, that can be used individually or grouped in a suite of modules, each module containing its own individual database, and connected via a middleware-like integration device, or Enterprise Service Bus, for network based data synchronization and communications, that connect the modules to each other and to existing ERP, CRM, data warehouse and custom legacy systems.

24. The method of establishing a system according to claim 1, that has data integration via a synchronization and communications device as a part of its inherent design, and is, as a result, fully supportive of Enterprise Application Integration (EAI), Enterprise Information Integration (EII), and other standards and organizations that encourage the sharing of information.

25. The method of establishing a system according to claim 1, that has data quality inherent in its design, whereby integrated data is generally of a higher quality (with established data rules and better conformity of the data to their rules) than stand alone data.

26. The method of establishing a system according to claim 1, that has data quality and data integration inherent in its design, whereby said data is generally more supportive of business intelligence (i.e. better function data warehouse, customer data repositories, etc.) than data found in stand alone applications and independent databases.
